(19) United States
(12) Patent Application Publication
(10) Pub. No.: US 2004/0145993 A1
(43) Pub. Date: Jul. 29, 2004

(54) Writing waveform controlling method and optical disk apparatus

(75) Inventors: Masaaki Kurebayashi, Ebina (JP); Hiroyuki Minemura, Kokubunji (JP); Tsuyoshi Toda, Kodaira (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 10/698,578

(22) Filed: Oct. 31, 2003

(30) Foreign Application Priority Data
Jan. 28, 2003 (JP) 2003-018165

(51) Int. Cl. G11B 7/00

(52) U.S. Cl. 369/53.37; 369/59.11; 369/47.53

(57) ABSTRACT

In a writing system in which the linear velocity changes during a write operation, it is difficult to determine the writing waveform parameters for all possible speeds through test write operation. Therefore, some representative values must be used to estimate them. This means that it is necessary to enhance the accuracy of this estimation process. The present invention determines a condition for a high speed and an optimum write condition for a low speed through test write operation and obtains a condition for a middle speed based on a recommended value written on the disk. Especially, the present invention can waveform-convert the waveform parameter for a multi-pulse portion of a multi-pulse writing waveform without changing its energy to produce an accurate waveform parameter.

### BACKGROUND OF THE INVENTION

1. Field of the Invention

The present invention relates to an optical disk apparatus for writing/reading information to/from a disk by use of a semiconductor laser, and more particularly to an optical disk apparatus for writing to a recording medium whose characteristics vary with the writing velocity.

2. Description of the Related Art

One prior art technique for writing to a writable optical disk while changing its linear velocity employs a constant angular velocity (CAV) writing method, as described on pages 5-7 and FIG. 1 of Japanese Patent Laid-Open No. 2003-6862. This prior art example uses a rewritable optical disk of a phase-change material, specifically a DVD-RAM. The above patent describes control information on the writing waveform used to write to the DVD-RAM by use of the CAV writing method. When a CAV writing method is used, since the linear velocity of the disk increases with increasing distance from the center of the disk toward the outer circumference, the write conditions must be changed depending on the linear velocity. Therefore, the patent also describes means for determining the write conditions.

### SUMMARY OF THE INVENTION

The above prior art technique includes a method for controlling write parameters when CAV writing is carried out. Specifically, parameters for CAV writing are determined based on the parameters for the inner and outer circumferences. However, this technique only provides a concept for, based on the conditions (parameters) for the inner and outer circumferences, determining writing waveform parameters for other linear velocities; it neither provides any specific example of how to obtain these parameters nor mentions the accuracy of the parameters (for other linear velocities) determined by use of the parameters for the inner and outer circumferences. Especially, when the writing waveform is controlled on a phase-change film as employed in embodiments of the above patent, it is necessary to consider optimizing the write conditions (parameters) for not only the front and back portions but also the multi-pulse portion between them. The above patent, however, mentions only that the write parameters for the front and back portions should be controlled.

The parameters for the innermost and outermost circumferences can be accurately determined through test write operation. As for the parameters for middle velocities, those written on the disk may be converted and used without performing any test write operation. With this arrangement, the accuracy can be enhanced without increasing the number of test write operations. However, since the parameters for middle velocities written on the disk are recommended parameters determined by the supplier when the disk is shipped, they may not be optimum when the disk is combined with a write apparatus. Furthermore, the performance has been enhanced by increasing the speed of the write operation, etc. Therefore, the recommended waveform may not be able to be output in high speed operation depending on the performance of the laser driver, etc. even though it is possible at low speed. However, no consideration has been given to changing waveform parameters so that they can be output.

It is, therefore, an object of the present invention to provide an optical disk apparatus whose write accuracy is high at a plurality of write speeds and which, based on the writing waveform parameters written on the optical disk, derives more desirable writing waveform parameters to provide high write accuracy.

To solve the above problems, an optical disk apparatus of the present invention comprises: an optical pickup for irradiating the laser light to the optical disk so as to receive reflected light from the optical disk and thereby read information written on the optical disk or to write information to the optical disk; a laser driver for controlling a laser of the optical pickup; a microcomputer for, by use of a converted writing waveform parameter obtained as a result of converting one of a plurality of writing waveform parameters each corresponding to one of a plurality of write speeds, deriving a writing waveform parameter corresponding to a write speed other than the plurality of write speeds, the plurality of writing waveform parameters being read from the optical disk by the optical pickup, the one of the plurality of writing waveform parameters corresponding to a predetermined write speed; and a digital control unit for controlling the laser driver by use of the writing waveform parameter derived by the microcomputer.

Further, another optical disk apparatus of the present invention comprises: an optical pickup for irradiating the laser light to the optical disk so as to receive reflected light from the optical disk and thereby read information written on the optical disk or to write information to the optical disk; a laser driver for controlling a laser of the optical pickup; a microcomputer for converting an original writing waveform parameter read from the optical disk by the optical pickup into another writing waveform parameter such that a waveform written with the another writing waveform parameter has the same energy as that of a waveform written with the original waveform parameter; and a digital control unit for controlling the laser driver by use of the another writing waveform parameter obtained by the microcomputer.

### BRIEF DESCRIPTION OF THE DRAWINGS

FIG. 1 is a block diagram showing a read/write apparatus according to a first embodiment of the present invention;

FIG. 2 is a flowchart for determining writing waveform parameters according to the first embodiment of the present invention;

FIG. 3 is an explanatory diagram showing writing waveforms;

FIG. 4 is a diagram showing how to correct writing waveforms;

FIG. 5 is a diagram showing an example of how to convert writing waveform parameters;

FIG. 6 is a diagram showing performance enhancement through correction of writing waveforms;

FIG. 7 is a flowchart for determining writing waveform parameters according to a second embodiment of the present invention;

FIG. 8 is an explanatory diagram showing writing waveforms; and

FIG. 9 is a diagram showing an example of how to adjust writing waveforms.

### DETAILED DESCRIPTION OF THE PREFERRED EMBODIMENTS

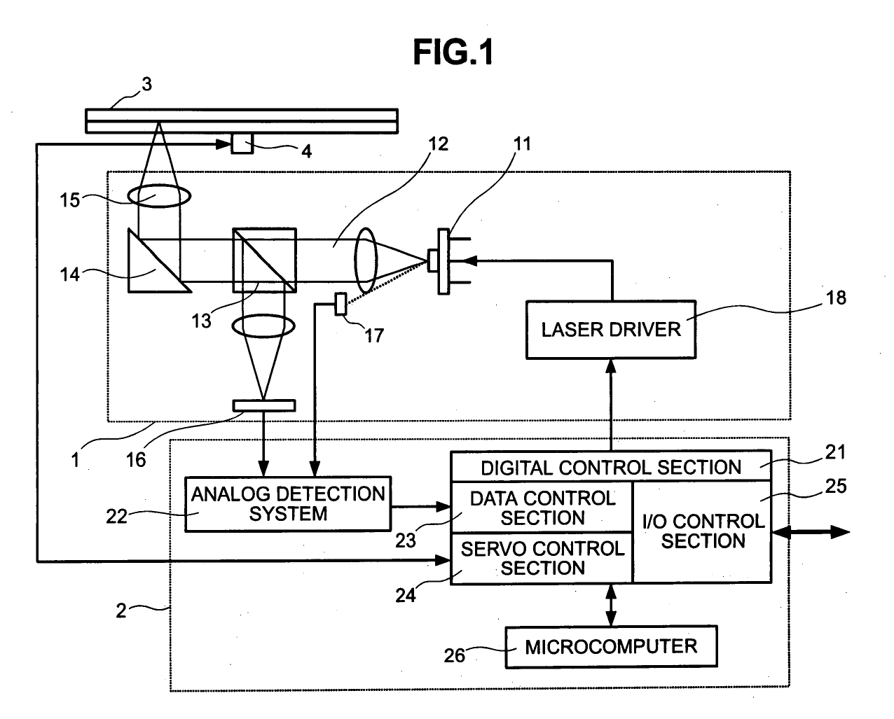

A first embodiment of the present invention will be described with reference to the accompanying drawings. FIG. 1 is a block diagram showing the configuration of the pickup and the main components of an optical disk read/write apparatus according to the first embodiment of the present invention. The read/write apparatus of the present embodiment comprises an optical pickup 1, a read/write circuit unit 2, a disk 3, a spindle motor 4, etc. The system of the present embodiment is a read/write system supporting DVD-RAMs, which are used as writable disks. A laser diode 11 has a wavelength of 660 nm and a maximum laser output of 100 mW. A laser driver 18 controls the laser diode 11. Specifically, the laser driver 18 controls the drive current and the optical power of the laser diode 11. The laser driver 18 also performs switching operation on the laser drive current according to a write signal to produce a predetermined write pulse waveform. Laser light 12 from the laser diode 11 enters an objective lens 15 by way of a beam splitter 13 and an upwardly directing prism 14. The objective lens 15 focuses the laser beam onto the medium of the disk 3, carrying out read/write operation.

When a read operation is performed, the light reflected from the disk 3 is directed to a detector 16 by the beam splitter. The returned light incident to the detector 16 is converted to an electric signal which is subjected to an operation in an analog detection system 22.

A portion of the light emitted from the laser 11 directly enters a front monitor 17 in which it is converted into an electric signal before being input to the analog detection system 22. The output of the front monitor 17 is proportional to the optical intensity of the laser and used to monitor and control the output of the laser such that it is maintained at a predetermined value.

The signal input to the analog detection system 22 is internally processed to generate a data signal and a servo signal which are then input to a digital control section 21. The digital control section 21 performs data signal and servo signal processing by use of a data control section 23 and a servo control section 24. Furthermore, the digital control section of the apparatus of the present embodiment includes an I/O control section 25 to exchange data with an external device.

The processing in the digital control section is performed by a microcomputer 26. The microcomputer performs processing for determining writing waveform parameters as well as controlling the operation of the apparatus. There are two ways of determining writing waveform parameters.

One way is to read the recommended parameters written on the disk and set these parameters as the writing waveform parameters. In this case, the light from the laser 11 is irradiated onto the disk 3 and the detector 16 detects the reflected light. Then, this signal (the reflected light) is detected by the analog detection system and decoded by the data control section 23 of the digital control section 21 to extract information from it. Since this information is used by the apparatus, it is subjected to internal processing (specifically it is processed by the microcomputer 26), instead of being externally read through the I/O control section 25.

The other way is to perform a test write operation to obtain optimum parameters. Specifically, a write operation is actually carried out on the disk 3 by use of the laser 11. The optimum conditions (parameters) are determined based on the characteristics of the (obtained) signal. This control is also performed by the microcomputer 26.

Description will be made below of an example of CAV writing actually using a DVD-RAM according the present embodiment.

Standards for the double speed (2X) and optional triple speed (3X) of DVD-RAM disks have been established. Therefore, to support these speeds, it is necessary to write information on the writing waveform parameters, etc. to the disk beforehand. A representative disk to which the present embodiment is applied is a DVD-RAM disk whose inner circumference (and outer circumference) set at 2X and 5 X and which can be written by use of a CAV writing method. This disk also satisfies the established standards for 2X and 3X, and therefore the conditions (parameters) for 2X and 3X determined by the disk media manufacturer are written in a specific area of the disk for 2X and 3X. Furthermore, the DVD-RAM disk of the present embodiment has the conditions (parameters) for 5X written thereon as writing waveform parameters in addition to the above conditions for 2X and 3X. That is, the recommended parameters for all three speeds (write conditions) are written on the disk.

These parameters can be used when CLV writing is performed at 2X, 3X, or 5X. However, if a linear velocity other than these three velocities is used, the drive side must set the parameters. When CAV writing is performed, the linear velocity of the disk gradually changes, with its inner and outer circumferences set at 2X and 5X, respectively. Therefore, the writing waveform parameters must be changed accordingly. The present embodiment derives the parameters for a multi-pulse portion set at an arbitrary speed from the parameters for the above three speeds.

It should be noted that since 2X and 5X are set to the inner and outer circumferences, respectively, data of these speeds can be obtained through trail write operation, in addition to the written parameters. As for 3X, however, its written parameters are only available. That is, as parameter data, it is possible to use the written data of 2X, 3X and 5X and the data of 2X and 5X obtained as a result of test write operations.

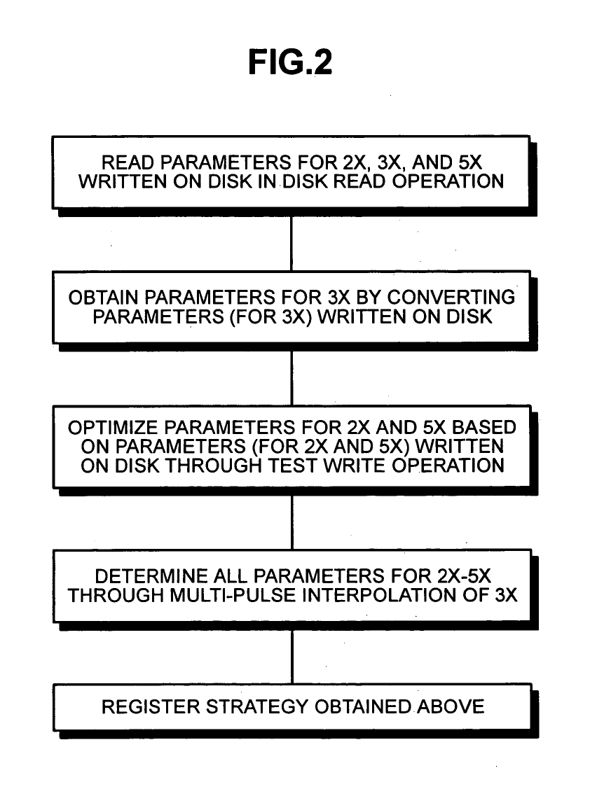

Description will be made of a procedure for determining parameters to be used when a DVD-RAM is written by a CAV writing method with its inner and outer circumferences set at 2X and 5X, respectively, in the read/write apparatus according to the present embodiment with reference to FIG. 2.

First of all, the parameters for 2X, 3X, and 5X are read and stored in the data control section 23. After that, a test write operation is carried out under the recommended conditions for 2X written on the disk to adjust the parameters and thereby determine optimum write conditions for the apparatus (2X corresponds to the linear velocity for the innermost circumference when CAV writing is performed). Then, a trial operation for the outermost circumference is carried out at 5X, that is, the linear velocity for the outermost circumference, to obtain optimum write conditions for the apparatus.

Then, the parameters for 3X written on the disk are converted by use of a method described later. These converted parameters for 3X, the optimum conditions (parameters) for 2X, and the optimum conditions (parameters) for 5X can be used to determine the writing waveform parameters for the speeds 2X-5X used when CAV writing is performed.

It should be noted that the parameters for 3X written on the disk themselves can be used (without converting them). However, since the parameters for 3X written on the disk are not interpolation data between 2X and 5X, adoption of them causes the parameters to change discontinuously (with changing speed) between 2X and 5X. This means that the waveform parameters discontinuously change as the linear velocity changes continuously when CAV writing is performed, making it difficult to control the operation. Another way, which is simpler than the above, is to interpolate data obtained as a result of test write operations at 2X and 5X. This method, however, may cause an accuracy problem even though it does not cause any problem when the linear velocity changes linearly between 2X and 5X, or there is an adequate margin with respect to the change of the writing waveform. Accordingly, to maintain the continuity of the parameters and enhance the write accuracy, the present embodiment has adopted the above method in which the parameters for 3X written on the disk are converted into parameters applicable to variable speed writing, and these converted parameters and the parameters for 2X and 5X are used to determine the writing waveform parameters for 2X-5X.

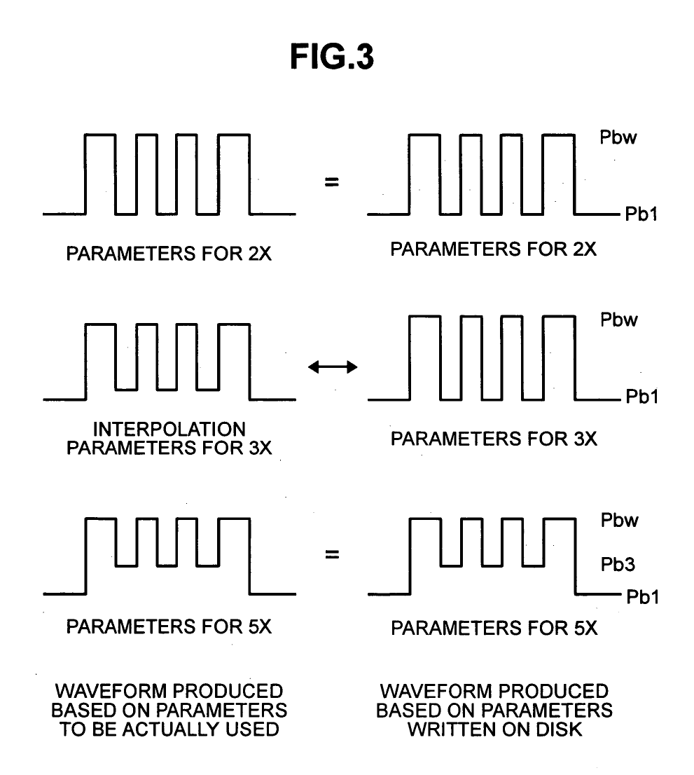

FIG. 3 shows writing waveforms according to the present embodiment. Specifically, FIG. 3 shows writing waveforms on a DVD-RAM. The three waveform parameters for 2X, 3X, and 5X shown in the right-hand side of FIG. 3 are written on the DVD-RAM disk according to the present embodiment. These parameters are basic waveforms obtained at their respective speeds. To determine the parameter for a multi-pulse portion, it is necessary to obtain the amount of energy of the multi-pulse portion for the period 1T. Since the amount of energy required increases with the linear velocity, the following inequality holds: 2X<3X<5X (in terms of their energy). As shown in FIG. 3, each multi-pulse portion is defined by its write power Pw and bias power Pb corresponding to the erasing power. There are two types of bias power Pb: the bias power Pb1 for the non-multi-pulse portion and the bias power Pb3 for the multi-pulse portion.

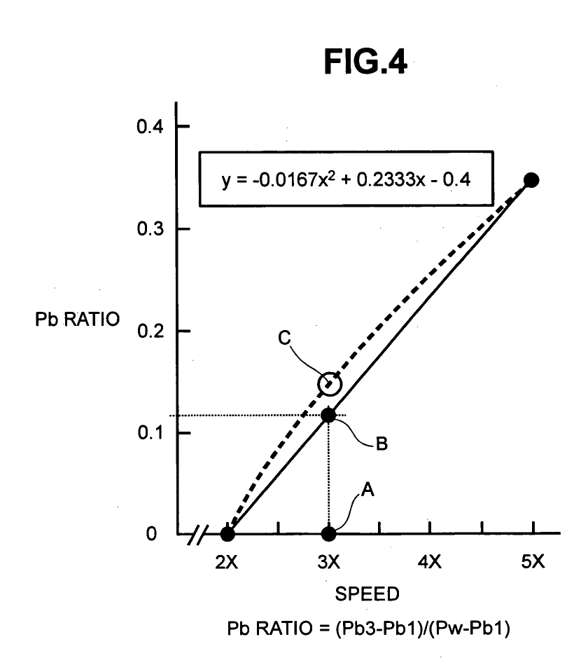

FIG. 4 shows results produced by the parameter determining method according to the present embodiment. FIG. 4 shows a Pb ratio as an example of parameter. The horizontal axis indicates the linear velocity, while the vertical axis indicates the Pb ratio. The Pb ratio is expressed by the equation: Pb ratio=( Pb3−Pb1)/(Pw−Pb1). That is, the Pb ratio is a parameter indicating the relationship between and Pb3. When Pb3=, Pb ratio=0; when Pb3=Pw, Pb ratio=1. Point A indicates the Pb ratio of the optimum writing waveform for 3X written on the disk. At point A, since Pb3=Pb1, Pb ratio=0. Point B, on the other hand, indicates a Pb ratio (approximately 0.12) at 3X obtained as a result of linear interpolation between 2X and 5X. Furthermore, point C is obtained through data conversion based on information at point A by use of a method described later. The Pb ratios at 2X and 5X obtained through test write operations and the converted Pb ratio (point C) at 3X are used to determine the Pb ratios for the speeds 2X-5X as indicated by the broken line.

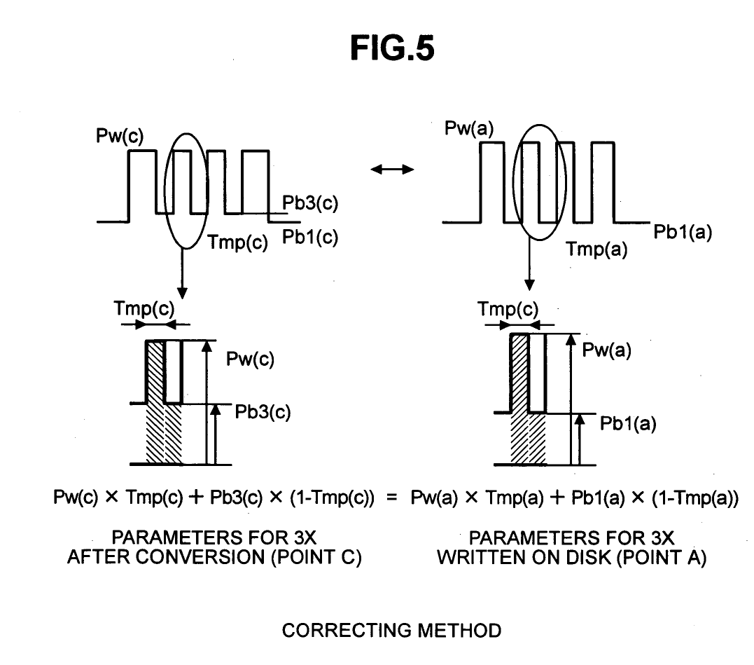

Description will be made below of how to convert parameters for 3X written on the disk to parameters (for 3X) to be actually used with reference to FIG. 5. That is, how to determine point C in FIG. 4 will be described. Each multi-pulse portion is set to have an equal amount of energy for the period 1T. Specifically, at point A, which indicates the predetermined pattern, the amount of energy is obtained by the formula: Pw(a)×Tmp(a)+(a)×(1-Tmp(a)). At point C, which indicates the converted strategy, on the other hand, the amount of energy is obtained by the formula: Pw(c)×Tmp(c)+Pb3(c)×(1-Tmp(c)). Assuming that the predetermined pattern is fixed, the parameters Pw(c), Tmp(c), and Pb3(c) may be adjusted to make both amounts of energy equal to each other. According to the present embodiment, this is accomplished by setting Pw(a)=Pw(c) and changing Pb3(c) and Tmp(c).

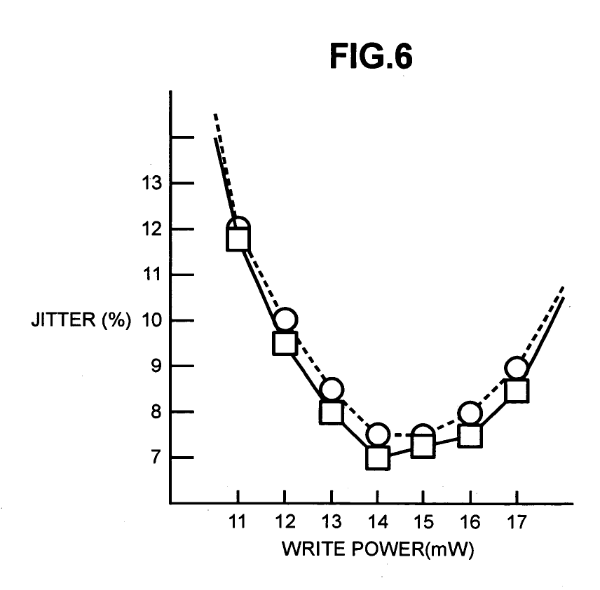

FIG. 6 shows actual correction results. In FIG. 6, the symbol 603 indicates the jitter value in a write operation at 4X under conditions set based on the parameters for 2X and 5X; its bottom value is 7.5%. The symbol □, on the other hand, indicates the jitter value in a write operation at 4X under conditions set based on the parameters for 2X, 3X, and 5X; its bottom value is 7%. As can be seen by comparison between both curves, use of the corrected data provides a better performance.

The present embodiment can determine an optimum waveform through calculation of the energy of the multi-pulse portion using the written parameters for 3X and thereby enhance the performance.

A second embodiment of the present invention will be described below. According to the first embodiment, the parameters for 2X-3X-5X (such as the parameters for 4X) are obtained based on (the data at) point C in FIG. 4. In addition, the present embodiment carries out a write operation using the parameters thus obtained and determines more accurate parameters using the results of the write operation.

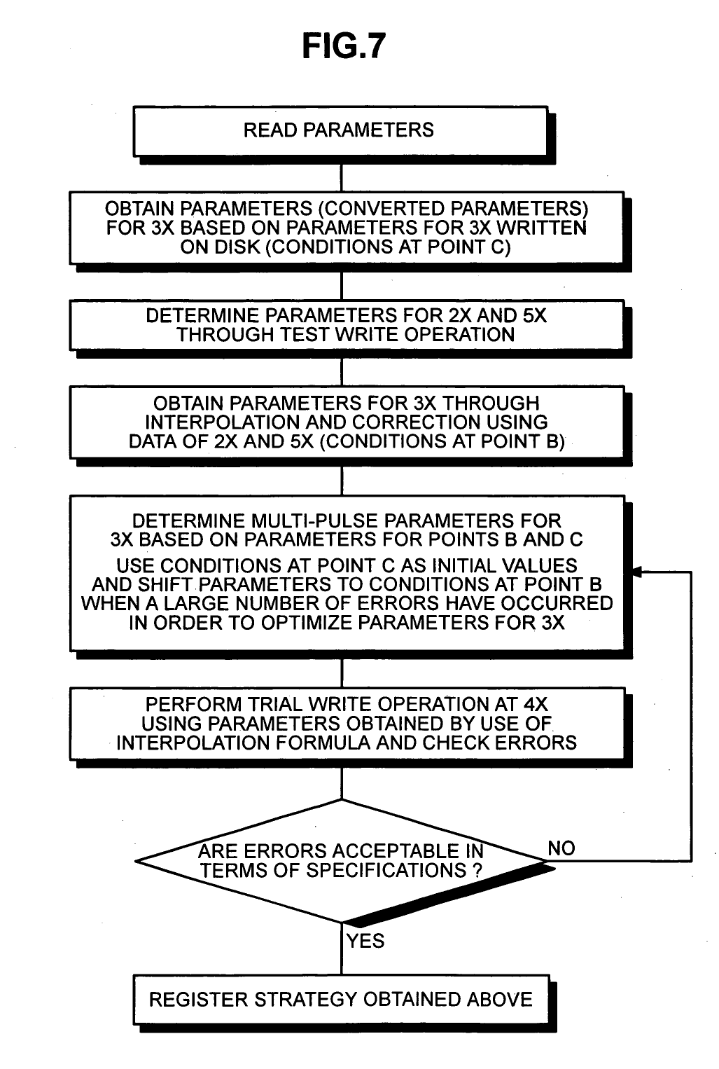

The second embodiment will be described with reference to FIG. 7. As in the first embodiment, the converted parameters for 3X are obtained after the basic parameters are read, and parameters for 2X and 5X optimum for the drive are obtained through actual test write operation.

Then, optimum parameters for 3X are calculated through interpolation based on the data of 2X and 5X obtained as a result of the test write operation. No problem arises if point B coincides with point C. If point B does not coincide with point C, however, one of them must be selected. Therefore, a test write operation is carried out to check the performance when each point is adopted. Ordinarily, a plurality of parameters are changed when a test write operation is performed. The above test write operation, however, is performed based on the determined parameters, checking whether the quality of the read signal satisfies the specifications.

Specifically, according to the present embodiment, point C is first set as an initial value (point). Then, a write operation is carried out at a predetermined speed, e.g. 4X, using the parameters at point C, and a determination is made as to whether a predetermined performance can be obtained. If the predetermined performance is obtained, the parameters for 2X-3X-5X can be used as the variable-speed writing waveform parameters for the drive. If the parameters at point C do not provide the predetermined performance, then the parameters at point B are used to check whether the predetermined performance can be obtained. This process is repeated to determine optimum parameters.

Thus, the second embodiment can check parameters at a middle speed, resulting in more accurate write operation.

A third embodiment of the present invention will be described below. As described above, when the performance has been enhanced by increasing the write speed to 2X, 3X, 5X or more, the recommended waveform may not be able to be output in high speed operation depending on the performance of the laser driver, etc. even though it is possible at low speed. In such a case, the writing waveform parameters may be changed such that the waveform can be output, by checking the performance of the apparatus and the writing waveform parameters themselves.

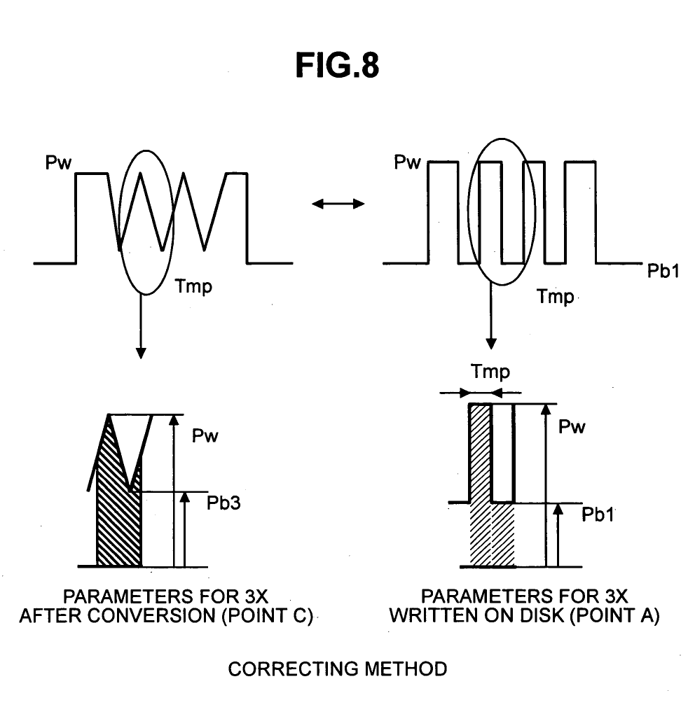

FIG. 8 shows an example of how to convert the writing waveform parameters written on a disk when the writing waveform cannot be produced. For example, when a write operation is performed based on the writing waveform (parameters) written on the disk, the performance limit of the write apparatus may prevent the generation of multi-pulses, producing a saw-tooth-like pulse as shown in the figure. Even in such a case, the writing waveform parameters can be adjusted to carry out the write operation if a certain amount of energy can be obtained (for each pulse).

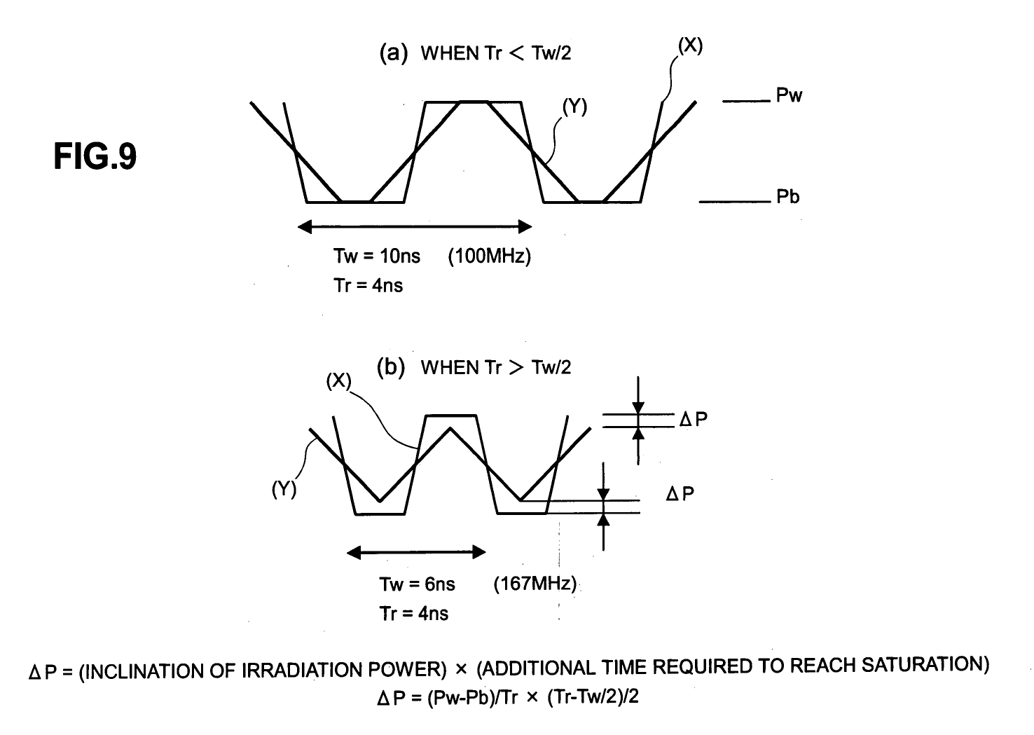

FIG. 9 shows a specific adjustment example. Consider the case where the writing waveform rises and falls at insufficient speed (an example of some characteristics of the apparatus being unfavorable). When the period Tw is set to 10 ns, for example, a write operation can be properly carried out with either of the waveform (X) having fast rise and fall times and the waveform (Y) having slow rise and fall times. When the write operation is carried out at high speed, however, a problem arises since the waveform (Y) shown in FIG. 9 (b) is produced even if the waveform parameters for the waveform (X) are set for the apparatus. Whether or not the write operation is properly carried out depends on the radio of the rise time Tr to the period Tw. If Tr>Tw/2, some parameters must be changed.

Specifically, let us reduce Pw and increase Pb by an equal amount of Δp (that is, Pw−Δp and Pb+Δp). Δp for producing an acceptable waveform is determined by the following equation.

Δp=(Pw−Pb)/Tr×(Tr−Tw/2)/2

Since the rise time Tr is determined by the write apparatus itself, it is arranged that when Tr and Tw satisfy the above condition (Tr>Tw/2), the parameters are automatically converted using the Δp value obtained from the above equation.

According to the present embodiment, a high-speed write operation can be performed even with an inexpensive laser driver having a comparatively slow rise time Tr.

The above embodiments were described as applied to DVD-RAMS. However, the present invention is not limited to them. Especially, disks of a phase-change material such as DVD-RWs and DVD+RWs use multi-pulses similar to those for DVD-RAMs and therefore the above energy conversion can be applied to their multi-pulse portions.

The present invention can perform control so as to optimize the writing waveform and thereby carry out an accurate write operation.

Furthermore, the present invention can convert the writing waveform parameters so as to properly write information even with a low-performance write apparatus (especially, a low-performance laser driver).

What is claimed is:

1. A method for controlling a writing waveform on an optical disk, in which laser light is irradiated to said optical disk to write information, said method comprising the steps of:
reading a plurality of writing waveform parameters each corresponding to one of a plurality of write speeds, said plurality of writing waveform parameters being written on said optical disk beforehand;
converting one of said plurality of writing waveform parameters into another writing waveform parameter by a predetermined method, said one of said plurality of writing waveform parameters corresponding to a predetermined write speed;
deriving still another writing waveform parameter corresponding to a write speed other than said plurality of write speeds by use of said another writing waveform parameter and a plurality of writing waveform parameters each corresponding to one of said plurality of write speeds other than a write speed corresponding to said another writing waveform parameter (said predetermined write speed); and
writing information to said optical disk by use of said still another writing waveform parameter.

2. The method as claimed in claim 1, further comprising a step of:
deriving still another writing waveform parameter corresponding to a write speed other than said plurality of write speeds by use of said another writing waveform parameter and a plurality of writing waveform parameters each corresponding to one of said plurality of write speeds other than a write speed corresponding to said another writing waveform parameter (said predetermined write speed).

3. A method for controlling a writing waveform on an optical disk in an optical disk apparatus in which information is written to said optical disk while a write speed is varied, said method comprising the steps of:
from optimum writing waveforms each established for one of a plurality of write speeds, determining a writing waveform parameter for an arbitrary speed other than said plurality of write speeds;
irradiating laser light to said optical disk based on said writing waveform parameter to write information; and
based on information on at least a first writing waveform parameter and a second writing waveform parameter optimum for a highest write speed and a lowest write speed, respectively, and a third writing waveform parameter optimum for a middle speed therebetween, deriving a writing waveform parameter for each speed between said highest speed and said lowest speed.

4. The method as claimed in claim 3, further comprising a step of:
in an optical disk writing system in which constant angular velocity (CAV) writing is performed with an outermost circumference and an innermost circumference (of said disk) set to said highest speed and said lowest speed corresponding to said first waveform parameter and said second writing waveform parameter, respectively, determining a writing waveform parameter for each speed between said inner(most) and outer(most) circumferences when CAV writing is performed based on said information on said third writing waveform parameter for said middle write speed between said innermost and outermost circumferences.

5. The method as claimed in claim 3, wherein said method uses a writing waveform configured such that:
said writing waveform has a multi-pulse portion and is divided into three blocks such as a front pulse, said multi-pulse portion, and an back pulse portion; and
in a long mark, said front and back pulses are fixed, and only the number of pulses of said multi-pulse portion changes with changing mark length.

6. The method as claimed in claim 5, further comprising a step of:
converting a writing waveform parameter such that average write energy of said multi-pulse portion (per unit time) is maintained at a same value for each linear velocity.

7. The method as claimed in claim 6, further comprising a step of:
continuously changing power of a bias portion to maintain write energy of said multi-pulse portion per unit time at a same value.

8. The method as claimed in claim 3, wherein:
said first writing waveform parameter (for said highest write speed) and said second writing waveform parameter (for said lowest write speed) are optimum parameters determined through test write operation; and
said third writing waveform parameter (for said middle write speed between said highest and lowest write speeds) is a recommended parameter for said middle write speed written on said disk beforehand.

9. A method for controlling a writing waveform on an optical disk in a system which uses a DVD-RAM as a recording medium and performs CAV writing on said DVD-RAM from an inner circumference at 2X to an outer circumference at 5X, said method using:
a writing waveform parameter for 5X as a first parameter;
a writing waveform parameter for 2X as a second parameter; and
a recommended writing waveform parameter for 3X written on said disk as a third parameter.

10. An optical disk apparatus for irradiating laser light to an optical disk to write information, comprising:
an optical pickup for irradiating said laser light to said optical disk so as to receive reflected light from said optical disk and thereby read information written on said optical disk or to write information to said optical disk;
a laser driver for controlling a laser of said optical pickup;
a microcomputer for, by use of a converted writing waveform parameter obtained as a result of converting one of a plurality of writing waveform parameters each corresponding to one of a plurality of write speeds, deriving a writing waveform parameter corresponding to a write speed other than said plurality of write speeds, said plurality of writing waveform parameters being read from said optical disk by said optical pickup, said one of said plurality of writing waveform parameters corresponding to a predetermined write speed; and
a digital control unit for controlling said laser driver by use of said writing waveform parameter derived by said microcomputer.

11. The optical disk apparatus as claimed in claim 10, wherein said microcomputer derives said writing waveform parameter corresponding to said write speed other than said plurality of write speeds by use of said converted writing waveform parameter and a plurality of writing waveform parameters each corresponding to one of said plurality of write speeds other than a write speed corresponding to said converted writing waveform parameter (said predetermined write speed).

12. A read/write apparatus comprising:
means for reading and analyzing parameters written on a disk;
means for analyzing said parameters and determining interpolation parameters; and
means for, based on at least a parameter for a highest speed, a parameter for a lowest speed, and a parameter for a middle speed, determining parameters for all possible speeds.

13. The read/write apparatus as claimed in claim 12, further comprising:
means for performing a trail write operation to obtain said parameter for said highest speed;
means for performing a test write operation to obtain said parameter for said lowest speed; and
means for, based on said parameters obtained through said test write operations and a third parameter for a middle speed written on said disk, determining said parameters for all possible speeds.

14. A method for controlling a writing waveform on an optical disk, in which laser light is irradiated to said optical disk to write information, said method comprising the steps of:
reading an original writing waveform parameter written on said optical disk beforehand;
converting said original writing waveform parameter into another writing waveform parameter such that a waveform written with said another writing waveform parameter has the same energy as that of a waveform written with said original writing waveform parameter; and
writing information to said optical disk by use of said another writing waveform parameter.

15. A method for controlling a writing waveform, comprising the steps of:
comparing an original writing waveform parameter for a write condition with a (light-emitting) shape of a writing waveform which can be output from a device under said write condition, said original writing waveform parameter being written on a disk beforehand; and
if it is determined that it is difficult to generate a (light-emitting) waveform indicated by said original writing waveform parameter written on said disk, changing said original writing waveform parameter into another writing waveform parameter such that a waveform written with said another writing waveform parameter has the same energy as that of a waveform written with said original writing waveform parameter.

16. An optical disk apparatus for irradiating laser light to an optical disk to write information, comprising:
an optical pickup for irradiating said laser light to said optical disk so as to receive reflected light from said optical disk and thereby read information written on said optical disk or to write information to said optical disk;
a laser driver for controlling a laser of said optical pickup;
a microcomputer for converting an original writing waveform parameter read from said optical disk by said optical pickup into another writing waveform parameter such that a waveform written with said another writing waveform parameter has the same energy as that of a waveform written with said original waveform parameter; and
a digital control unit for controlling said laser driver by use of said another writing waveform parameter obtained by said microcomputer.

17. An information read/write apparatus comprising:
means for storing a parameter that allows determining a performance of a writing (light-emitting) waveform which can be output;
means for determining whether it is possible to generate a light-emitting waveform indicated by a recommended parameter written on a disk;
means for, if it is difficult to generate said light-emitting waveform, converting an original waveform parameter (said recommended parameter) into another parameter such that a waveform written with said another parameter has the same energy as that of a waveform written with said original waveform parameter (said recommended parameter); and
means for generating a writing waveform by use of said another parameter.

18. A method for writing information to an optical disk by irradiating laser light thereto, said optical disk storing:
a first writing waveform parameter for a first write speed;
a second writing waveform parameter for a second write speed higher than said first write speed; and
a third writing waveform parameter for a third write speed higher than said second write speed; said method comprising the step of:
writing information at said second write speed by use of a fourth writing waveform parameter obtained as a result of converting said second writing waveform parameter.

19. The method as claimed in claim 18, further comprising steps of:
writing information at said first write speed by use of a fifth writing waveform parameter obtained as a result of a trail write operation at said first write speed;
writing information at said third write speed by use of a sixth writing waveform parameter obtained as a result of a test write operation at said third write speed; and
writing information at said second write speed by use of a writing waveform parameter obtained as a result of approximating said fourth writing waveform parameter.

20. The method as claimed in claim 18, wherein energy received by said optical disk when laser light is irradiated based on said second writing waveform parameter is substantially equal to that received by said optical disk when laser light is irradiated based on said fourth writing waveform parameter.

21. The method as claimed in claim 20, wherein:
said second writing waveform parameter includes a parameter for a multi-pulse component of laser light to be irradiated; and
said method further comprises a step of:
obtaining said fourth writing waveform parameter by changing bias power of a multi-pulse component of said second writing waveform parameter.

22. The method as claimed in claim 20, wherein:
said second writing waveform parameter includes a parameter for a multi-pulse component of laser light to be irradiated; and
said method further comprises a step of:
obtaining said fourth writing waveform parameter by changing write power of a multi-pulse component of said second writing waveform parameter.

23. The method as claimed in claim 20, wherein:
said second writing waveform parameter includes a parameter for a multi-pulse component of laser light to be irradiated; and
said method further comprises a step of:
obtaining said fourth writing waveform parameter by changing a pulse width of a multi-pulse component of said second writing waveform parameter.
